(19) United States
(12) Patent Application Publication
(10) Pub. No.: US 2020/0382509 A1
(43) Pub. Date: Dec. 3, 2020

(54) CONTROLLING ACCESS TO COMMON DEVICES USING SMART CONTRACT DEPLOYED ON A DISTRIBUTED LEDGER NETWORK

(71) Applicant: HEWLETT PACKARD ENTERPRISE DEVELOPMENT LP, Houston, TX (US)

(72) Inventors: Ananth Narayanan Easwar Prasad, Bangalore (IN); Subbulakshmi Kallidaikurichi Viswesvaran, Bangalore (IN); Fazlur Rahman Sit Mohamed Ali, Bangalore (IN)

(21) Appl. No.: 16/427,271

(22) Filed: May 30, 2019

(51) Int. Cl. H04L 29/06

(52) U.S. Cl. CPC H04L 63/102; H04L 9/3247; H04L 63/08

(57) ABSTRACT

Some implementations of the disclosure are directed to receiving authentication data from a user attempting to access a common device on a network; determining, using at least the authentication data, if the user is a local user of the network; responsive to the user not being a local user of the network: querying a smart contract on a distributed ledger network to determine whether or not to grant the user access to the common device, wherein the query comprises the authentication data of the user; and controlling the user's access to the common device based on an output received from the smart contract in response to the query.

### DESCRIPTION OF RELATED ART

A network such as a local area network (LAN) may have certain common devices such as printers, scanners, etc. For security purposes, it may be important to know who has been accessing and using a common device at a given point of time. Typically usage of a common device such as a printer is logged by the printer or a log server.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate the reader's understanding of various embodiments and shall not be considered limiting of the breadth, scope, or applicability of the present disclosure. It should be noted that for clarity and ease of illustration these drawings are not necessarily made to scale.

FIG. 1 illustrates one example network configuration that may be implemented for a multi-user organization, in accordance with implementations of the disclosure.

FIG. 2 is an operational flow diagram illustrating an example method that may be implemented to provide access to and log common device usage, in accordance with implementations of the disclosure.

FIG. 3 illustrates an example configuration of a local networking system in which embodiments may implemented, in accordance with implementations of the disclosure.

FIG. 4 is a schematic block diagram illustrating one particular example of a controller, in accordance with implementations of the disclosure.

FIG. 5 is an operational flow diagram illustrating an example method in accordance with implementations of the disclosure.

FIG. 6 is an operational flow diagram illustrating an example method that may be implemented by a smart contract in accordance with implementations of the disclosure.

The figures are not intended to be exhaustive or to limit various embodiments to the precise form disclosed. It should be understood that various embodiments can be practiced with modification and alteration.

### DETAILED DESCRIPTION

As used herein, the term “distributed ledger” generally refers to a shared digital ledger that is decentralized and shared between nodes distributed across a network. After a transaction that is approved to be written to the ledger is consented by at least the majority of the nodes, the contents of the ledger are synchronized across all the nodes. Different types of consensus mechanisms that bring in varying levels of processing requirements to agree on a transaction amongst distributed nodes may be utilized in a distributed ledger network. Examples of common consensus mechanisms include proof of work, proof of stake, proof of elapsed time, Kafka, etc. Various platforms have adopted different consensus mechanisms.

Distributed ledger technology (DLT) describes the superset of the different variations of this technology. One presently popular type of DLT is blockchain technology. While in a distributed ledger a transaction is written to the ledger after consensus, the requirement is more specific in a blockchain: transactions are aggregated in to a block and the block is appended to the last block of an existing linear chain of blocks. As such, all blockchains are a form of a distributed ledger, but all distributed ledgers are not necessarily a blockchain. BITCOIN and ETHEREUM are examples of blockchain-based platforms. Directed acyclic graphs (DAG) are another example of a common form of DLT. IOTA is an example of a DAG-based platform. HYPERLEDGER is an example of a DLT-based platform. Unless explicitly stated otherwise, implementations of the disclosure may apply to any variant of DLT, including blockchains, DAGs, etc., in a public, private, and/or hybrid networking environment.

Although embodiments of the disclosure will be primarily described in the context of blockchains, it should be appreciated that all embodiments, unless expressly stated otherwise, may be applied to other variants of distributed ledger technology. For example, to the extent an embodiment is described in the context of a blockchain network sharing a blockchain, it should be appreciated that the embodiment may more generally be applied in a distributed ledger network sharing a distributed ledger. Similarly, to the extent that an embodiment recites a “blockchain address,” “a blockchain application,” or “a blockchain transaction,” it should be appreciated that the embodiment may more generally be applied using a “distributed ledger address,” “a distributed ledger application,” and/or “a distributed ledger transaction.”

As used herein, the term “public blockchain” generally refers to a blockchain that is accessible to any entity and whereby any entity may participate in the consensus process. A public blockchain may be referred to as a “fully decentralized” blockchain.

As used herein, the term “private blockchain” generally refers to a blockchain where a limited set of trusted entities participate in a blockchain network. A permissioned set of trusted nodes may participate in the consensus process. For example, a set of site controllers or edge servers of an enterprise may form a private blockchain network. The right to read a private blockchain may be public or restricted to trusted nodes. A private blockchain may be referred to as a permissioned blockchain. Although implementations of the disclosure will primarily be described in the context of private blockchains, it should be appreciated that the technology disclosed herein may be adapted for use in anything from public to private blockchains.

As used herein, the term “blockchain address” refers to an identifier for a receiver or a sender in a blockchain recorded transaction. For example, a unique blockchain addresses may be associated with a client.

As used herein, the terms “off-chain” and “off-chain transaction” refer to transactions that do not occur within a blockchain.

As used herein, the term “smart contract” refers to self-executing code residing on a blockchain network, which automates execution of contracts between trusted parties based on events on a blockchain or distributed ledger.

As used herein, the term “common device” refers to a networked device configured to be accessed by a plurality of permissioned users. For example, a common device may refer to a printer, a scanner, a projector, a display, a speaker, or a terminal.

Typical usage of common devices (e.g., printers, projectors, displays, etc.) in a local network may suffer from multiple issues. For example, deciding access to common devices by guest users may be a cumbersome process that requires information technology (IT) manual intervention, including the configuration of authentication credentials and authorization privileges by a local network administrator. Additionally, logging of common device usage in networks may not be reliable. Having the common device itself or a storage server maintain logs of common device use may present security issues, as the data may be susceptible to unauthorized modifications and data loss through malware attacks.

Implementations of the disclosure are directing to address these and other problems that arise in networks that provide controlled access to common devices and/or logging of common device usage. To this end, implementations of the disclosure implementations of the disclosure are directed to leveraging a smart contract self-executing on a blockchain network to regulate access to common device and log common device usage. By virtue of such implementations, various advantages may be achieved. For example, the use of a smart contract may provide a simpler way of sharing common devices (e.g., printers) in a network compared to the way they are presently shared. Additionally, this may provide a mechanism for preventing tampering as the smart contract that regulates access may be part of an immutable blockchain. Moreover, a smart contract may be configured to cause logs of usage to be stored on a blockchain, thereby providing for data integrity, including traceability of common device usage, and, in some implementations, a record of changes that were made to a common device.

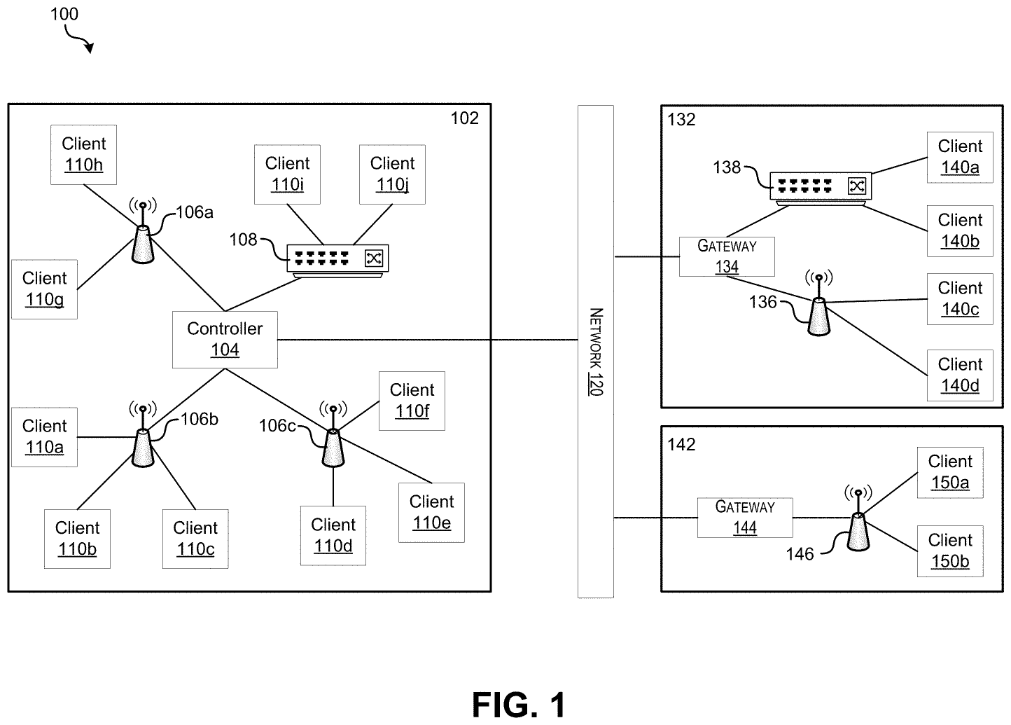

Before describing implementations of the technology described herein, it is instructive to describe an example network configuration in which embodiments may be implemented. FIG. 1 illustrates one example network configuration 100 that may be implemented for a multi-user organization, in accordance with implementations of the disclosure. For example, the multi-user organization may be a business enterprise, educational institution, governmental entity, or any other organization having multiple users and possibly multiple physical or geographical sites. The network configuration 100 may include headquarters or main office 102 in communication with a network 120. The network configuration 100 may also include one or more remote sites 132, 142, also in communication with the network 120.

The main office 102 may include a primary network, which may also be called a corporate network or a home network. The main office 102 network may be a private network that may include security and access controls, such that only certain users are authorized to access the private network. Authorized users may include, for example, employees of a company based in the main office 102.

In the illustrated example, the main office 102 includes a controller 104 in communication with the network 120. The controller 104 may provide communication with the network 120 for the main office 102, though it may not be the only point of communication with the network 120 for the main office 102. A single controller 104 is illustrated, though the main office may include multiple controllers and/or multiple communication points with network 120. In some embodiments, the controller 104 communicates with the network 120 through a router (not illustrated). In other embodiments, the controller 104 provides router functionality to the devices in the main office 102.

A controller 104 may be operable to configure and manage network devices, such as in the main office 102, and may also manage network devices at the remote sites 132, 134. The controller 104 may be operable to configure and/or manage switches, routers, access points, and/or client devices connected to a network. The controller 104 may itself be, or provide the functionality of, an access point.

The controller 104 may be in communication with one or more switches 108 and/or wireless access points 106a-c. Switches 108 and wireless access points 106a-c may provide network connectivity to various client devices 110a-j. Using a connection to a switch 108 or access point 106a-c, a client device 110a-j is able to access network resources, including other devices on the network and the network 120.

Examples of client devices may include, but are not limited to: desktop computers, laptop computers, smartphones, tablets, servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, and the like. Client devices may also include common devices such as printers, projectors, televisions and similar monitors, terminals, video game consoles, and the like. Depending on access rights, one or more local users (e.g., employees of office where common device is present) or non-local users (e.g., guests of office, employees of another branch office, etc.) may be granted access to these common devices. As further discussed below, access to these common devices may be controlled and logged using a smart contract.

Within the main office 102, a switch 108 is included as one example of a network access device (NAD) that provides a point of access to the network for wired client devices 110i-j. Client devices 110i-j may connect to the switch 108 and, through the switch 108, may be able to access other devices within the network configuration 100. The client devices 110i-j may also be able to access the network 120, through the switch 108. The client devices 110i-j may communicate with the switch 108 over a wired connection. Wireless access points 106a-c are included as another example of NADs that provide a point of access to the network for client devices 110a-h. An access point 106a-c may be a combination of hardware, software, and/or firmware that is configured to provide wireless network connectivity to wireless client devices 110a-h. In the illustrated example, the access points 106a-c may be managed and configured by the controller 104. The access points 106a-c may communicate with the controller 104 and the network over either wired 112 or wireless connections.

The network configuration 100 may also include one or more remote sites 132. A remote site 132 may be located in a different physical or geographical location from the main office 102. In some cases, the remote site 132 may be in the same geographical location, or possibly the same building, as the main office 102, but lacks a direct connection to the network located within the main office 102, relying instead on a connection over a different network 120. A remote site 132 such as the one illustrated may be, for example, a satellite or branch office. The remote site 132 may include a gateway device 134 for communicating with the network 120. A gateway device 134 may be a router, a digital-to-analog modem, a cable modem, a Digital Subscriber Line (DSL) modem, or some other network device configured to communicate to the network 120. The remote site 132 may also include a switch 138 and/or access point 136 in communication with the gateway device 134 over either wired or wireless connections. The switch 138 and access point 136 may provide connectivity to the network for various client devices 140a-d. In some implementations, the remote site 132 may include a controller (e.g., integrated into gateway 134) operable to configure and/or manage switches, routers, access points, and/or client devices of remote site 132 connected to the network.

In some implementations, the remote site 132 is in direct communication with main office 102, such that client devices 140a-d at the remote site 132 access the network resources at the main office 102 as if these client devices 140a-d were located at the main office 102. In such implementations, the remote site 132 may be managed by the controller 104 at the main office, and the controller 104 may provide the necessary connectivity, security, and accessibility that enable the remote site's 132 communication with the main office 102.

In some implementations, the network configuration 100 may include one or more smaller remote sites 142, comprising only a gateway device 144 for communicating with the network 120 and a wireless access point 146, by which various client devices 150a-b access the network 120. Such a remote site 142 may represent, for example, an individual employee's home or a temporary remote office. The remote site 142 may also be in communication with the main office 102, such that the client devices 150a-b at remote site 142 access network resources at the main office 102 as if these client devices 150a-b were located at the main office 102. The remote site 142 may be managed by the controller 104 at the main office 102 (for example by pushing configurations from 104 to 134) to make this transparency possible. Alternatively, the remote site 142 may include its own controller (e.g., integrated into gateway 144), which maybe independently configured or may receive its configurations from 102.

The network 120 may be a public network, such as the Internet. A public network is a network that may be shared by any number of entities, including the illustrated network configuration 100. A public network may have unrestricted access, such that any user may connect to it. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers that are not directly part of the network configuration 100 but that facilitate communication between the various parts of the network configuration 100, and between the network configuration 100 and other network-connected entities.

In some implementations, the network configuration 100 may include a cloud-based management service (not shown) for configuring and/or managing network devices at the main office 102 and/or remote sites 132, 142. In such implementations, the main office 102 may include a gateway instead of a controller 104. The management service may be running on a server local to the main office 102, or a server located remotely from the main office 102, or may be distributed across any number of local and/or remote servers.

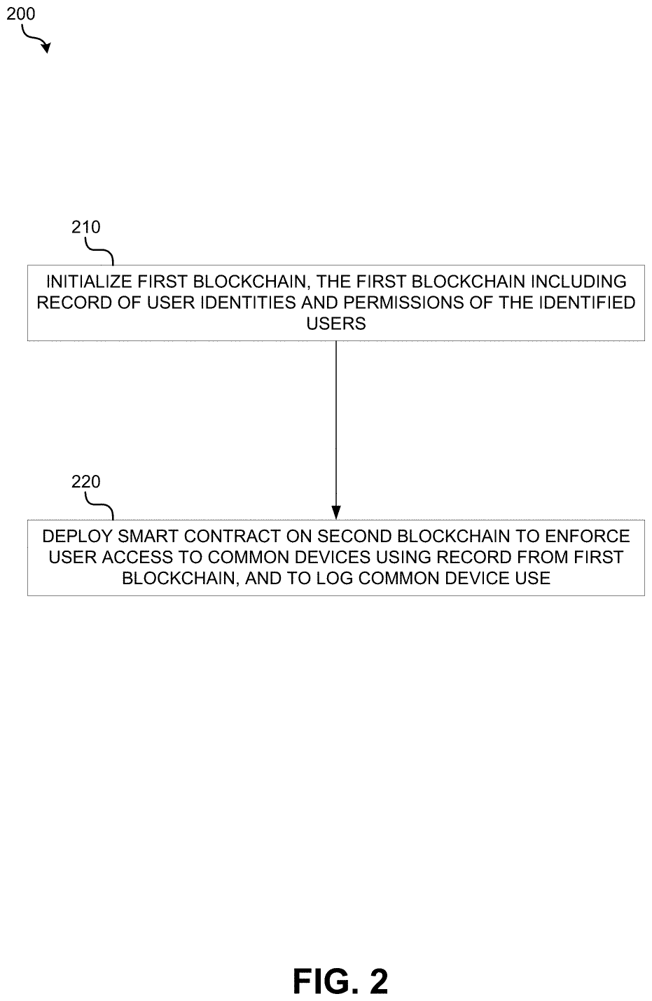

FIG. 2 is an operational flow diagram illustrating an example method 200 that may be implemented to provide access to and log common device usage, in accordance with implementations of the disclosure. For example, method 200 may be implemented by an enterprise having the network configuration 100. At operation 210, a first blockchain is initialized, the first blockchain including a record of user identities and access permissions granted to the identified users with respect to common devices. For example, the record may include user credentials such as a user ID and password, a public key associated with each user, or some other record that may be used to identify users. The users may include employees and/or guests of the enterprise.

In some implementations, each user may be granted a specific set of permissions (e.g., allow access, deny access, limited access) with respect to each common device that is part of the network configuration 100. In other implementations, user permissions may be grouped. For example, some employees may be authorized to access all common devices whereas other employees may only be authorized to access common devices that are present in their local office. As another example, guest users may be authorized to access a specific type of common device while not being allowed access to any other type of common device.

In various implementations, the first blockchain may be a permissioned blockchain. For example, during initialization, access to the first blockchain may be provided to a permissioned set of users such as network administrators of the enterprise. The permissioned set of users may each be respectively assigned a private key to write transactions to the blockchain. In such instances, only the permissioned users may read information stored in the blockchain (e.g., read the record of permissions), write information indicating changes to permissions, and/or participate in a consensus mechanism for verifying changes that are made to the permissions. In some implementations, the identities of employees of the enterprise and/or guests of the enterprise along with their permissions with respect to common devices may be added to the first blockchain by permissioned users.

In particular implementations, an administrator of each office (e.g., main office 102 or remote offices 132, 142) may be designated as a permissioned user. In such implementations, as additional offices are added, additional permissioned users may be designated. For example, consider the case of an enterprise having various franchisees. In such implementations, each franchisee may be granted access to designate common device permissions for users that are present at the franchise. As more franchisees are added, additional permissioned users may be granted access to the blockchain.

At operation 220, a smart contract is deployed on a second blockchain to enforce user access to common devices using records stored on the first blockchain, and to log usage of common devices. In implementations, the second blockchain may also be a permissioned blockchain. For example, the second blockchain may have the same permissioned users as the first blockchain.

The use of a first blockchain to maintain a record of user identities and access permissions and a separate, second blockchain in which the smart contract is deployed may confer the advantage of securing the smart contract from modification, inadvertent or intentional, as it may be preferable not to modify the smart contract after deployment. As such, when the record/list of users of the first blockchain is modified (e.g., by a permissioned administrator), the smart contract may not be inadvertently modified. On the other hand, if the smart contract were deployed on the same blockchain, there may be the risk of the smart contract being inadvertently modified by an administrator.

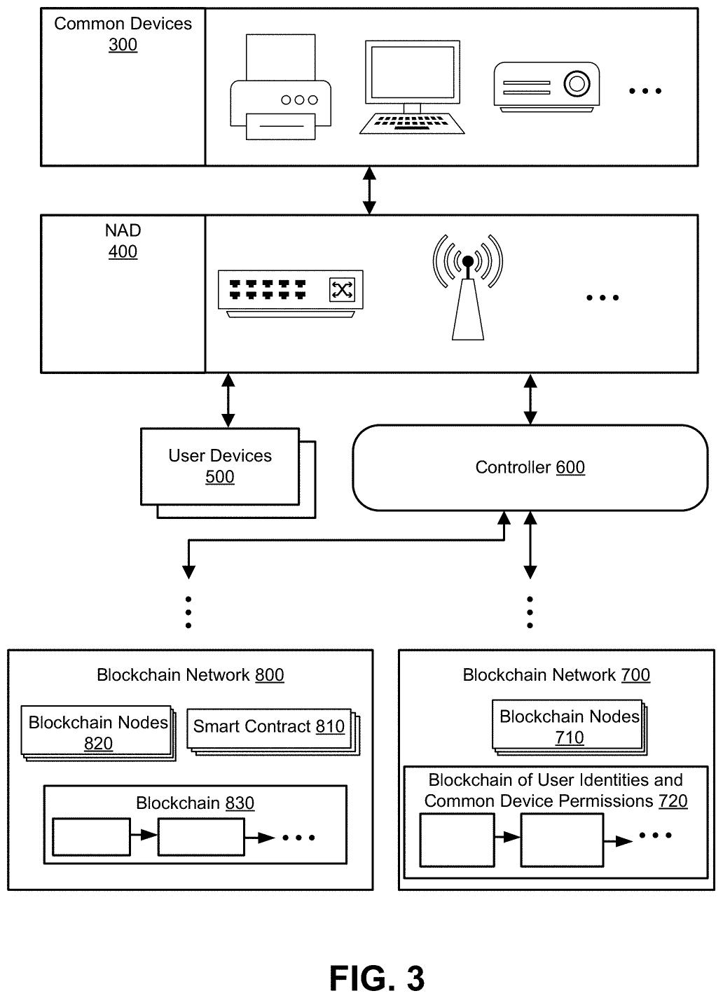

FIG. 3 illustrates an example configuration of a local networking system in which embodiments may implemented, in accordance with implementations of the disclosure. The networking system of FIG. 3 may correspond to site of a multi-user organization, such as a business, educational institution, governmental entity, or any other organization having multiple users. For example, FIG. 3 may correspond to a local network of a main office 102 or remote sites 132, 142. The networking system may correspond to a local area network (LAN) of an office of an enterprise. It should be noted that although embodiments have thus far been described in the context of a multi-site organization, the implementations described herein could also apply to single site organizations. Moreover, it should be noted that some implementations of the disclosure may take place in Software-Defined Wide Area Networks (SDWAN) whereby multiple entities/franchisees that do not necessarily trust each other have to allow and/or deny usage of each other's devices.

As shown in this example, the networking system includes a controller 600 that may provide and control access to one or more networks (e.g., the Internet, an enterprise network including common devices that part of the enterprise network, etc.) and one or more NAD 400, by which various user devices 500 may access the one or more networks. For example, the NAD 400 may be implemented as one or more switches, wireless access points (AP), or some combination thereof, that provides network connectivity to various user devices 500. Using a connection to a NAD 400, a user device 500 may access network resources, including common devices 300 on the network. Examples of user devices 500 include, but are not limited to: desktop computers, laptop computers, smartphones, tablet computers, etc. As shown in this example, one or more common devices 300 may be shared by user devices 500 in the networking system. Examples of common devices may include, for example, a printer, a projector, a scanner, a terminal, a television, a camera, etc.

Controller 600 may be configured to communicate with a blockchain network 700 including a plurality of blockchain nodes 710 and a blockchain 720 including a record of user identities and common device permissions. In some implementations controller 600 may be configured as one of the blockchain nodes 710 of blockchain network 700. For example, each of the blockchain nodes 710 may correspond to a controller or edge server located at an office of the enterprise. As users are added, removed, or modified, corresponding common device permissions may be updated on the blockchain 720. By way of example, when a guest user first accesses the local network shown in FIG. 3, the guest user's identity along with common device permissions may be added to the blockchain 720. In some implementation, the current record of user identities and common device permissions may be accessed for the last block that was added to the blockchain 720. In some implementations, blockchain network 700 may be initialized as discussed above with reference to operation 210 of method 200.

In some implementations, the record of user identities and common device permissions may be maintained in a local database and/or centralized database. Such databases may be maintained as an alternative to or in addition to the blockchain 720. For example, a controller 600 or edge server of a corresponding site may maintain a local database including common device permissions for local users.

As noted above, some of the issues with traditional management of common devices 300 in networks is that deciding access to common devices by users such as guest users may be a cumbersome process and logging of common device usage in networks may not be reliable, including being the subject of security concerns. To address these aforementioned issues, controller 600 may be configured to communicate with a blockchain network 800 including a plurality of blockchain nodes 820, a smart contract 810, and a blockchain 830. In some implementations controller 600 may be configured as one of the blockchain nodes 820 of blockchain network 800. For example, each of the blockchain nodes 820 may correspond to a controller or edge server located at an office of the enterprise.

In this example, smart contract 810 may be deployed on blockchain network to determine access rights of a user device 500 attempting to access a common device 300. Additionally smart contract 810 may be deployed to log access of and use of common devices 300. For example, smart contract 810 may be deployed as discussed above with reference to method 200. Smart contract 810 may be replicated across each copy of a blockchain 830 stored by a permissioned node on blockchain network 800. For example, controller 600 and other blockchain nodes 820 may each store a copy of a blockchain 830 including an instance of smart contract 810.

In some implementations, execution of code contained in the smart contract 810 may be triggered by user identification data and common device identification data received as an input from a device. For example, the data may be received from a permissioned node (e.g., controller 600) operating on blockchain network 800. The data may include the credentials supplied by a user device 500 along with an identification of a common device 300 the user device 500 is attempting to access. Upon execution of the code, smart contract 810 may use at least the received data along with a record of user identities and common device permissions, to determine if the requesting user device 500 is authorized to access the common device 300. In the illustrated example, smart contract 810 may make this determination by referring to a blockchain of user identities and common device permissions 720 (e.g., by referring to the last block in the chain). However, in other implementations, some other data structure (e.g., centralized database maintained outside of a blockchain, database maintained by the smart contract, etc.) may be used to make the determination.

Depending on whether or not the user is authorized to access the common device, smart contract 810 may perform certain on-chain actions and/or off-chain actions. For example, smart contract 810 may cause access to the common device 300 to be granted or denied to the requesting user. Additionally, smart contract 810 may create a log of common device access or denial, including what common device was accessed, and how the common device was utilized. In some implementations, once the smart contract 810 determines whether or not a user has the necessary privileges, it may give instructions to the controller 600 and the controller may subsequently enforce the decision (e.g., using a NAD 400).

In other implementations, the smart contract 810 may directly interact with the common device 300 itself. For example, if the common device 300 is a printer that receives an instruction from the smart contract 810 to print, only then it will execute it. In such implementations, the requesting user device 500 may connect to the printer directly (e.g., using an ad-hoc wireless connection) and the printer may then contact the smart contract. In such cases, the smart contract may verify if the user is a valid user and give the access control instruction directly to the printer. In yet other implementations, the functionality for contacting the smart contract for verifying whether a user is authorized to use the common device may be implemented by a NAD 400 or some other device in the local network. As such, although in the example of FIG. 3 a controller 600 is shown as communicating with blockchain networks 700 and 800, it should be appreciated that some other device of the local network (e.g., a NAD, gateway, edge server, etc.) may be configured to communicate with blockchain network 800 to query the smart contract 810 and/or blockchain network 700 to update the blockchain of user identities and common device permissions 720.

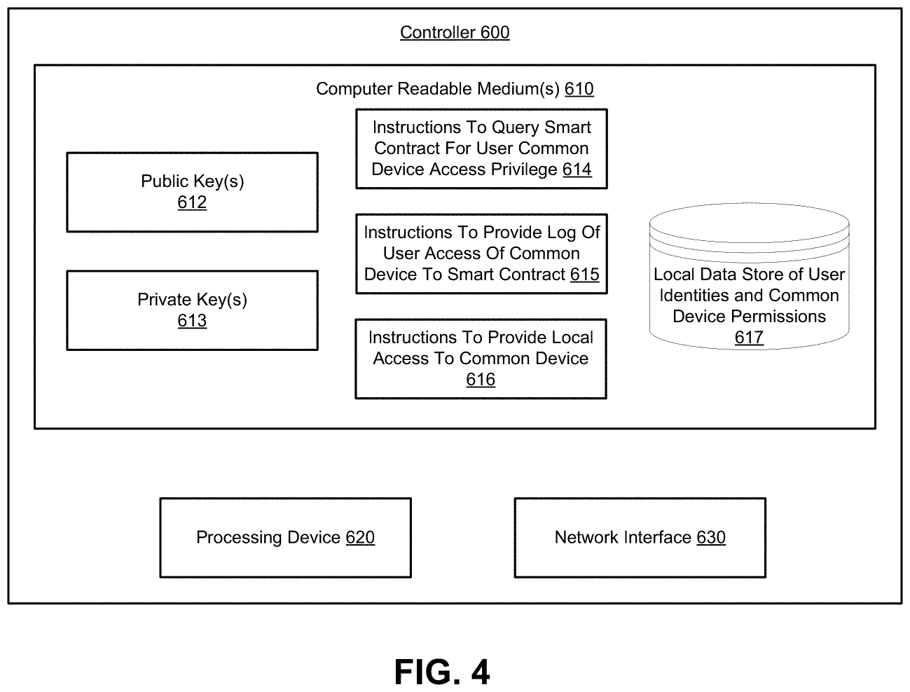

FIG. 4 is a schematic block diagram illustrating one particular example of a controller 600, in accordance with implementations of the disclosure. As illustrated, a controller 600 may include one or more computer readable mediums 610, a processing device 620 (e.g., a processor to execute machine readable instructions such as instructions 614-616), and a network interface 630 to communicate with other network devices.

As illustrated, controller 600 may store its own public key(s) 612 and private key(s) 613 that may correspond to blockchain addresses used for blockchain transactions on blockchain networks 700 and/or 800. For example, for each blockchain network, a private key 613 may be generated through a blockchain application, a public key 612 may be derived from the private key 613, and a blockchain address may be derived from the public key 612 by applying additional cryptographic algorithm(s). In some implementations, the public key 612 and blockchain address are the same. In some implementations, controller 600 may also store a copy of blockchain 720 and/or blockchain 830. Private key(s) 613 may be uniquely known by controller 600, and may be used to digitally sign transactions that are submitted to the blockchain network 700 and/or blockchain network 800 for verification.

Controller 600 may include a local data store 617 of user identities of common device permissions including user information that is used to authorize access to common devices to local users. For example, local users may include employees on the same local area network as the controller 600.

Controller 600 may further store instructions 614 that may be executed by processing device 620 to query a smart contract (e.g., smart contract 810) for user common device access privileges. Controller 600 may further store instructions 615 that may be executed by processing device 620 to provide a log of user access of common devices to smart contract 615. Controller 600 may further store instructions 616 that may be executed by processing device 620 to provide a local user with access to a common device.

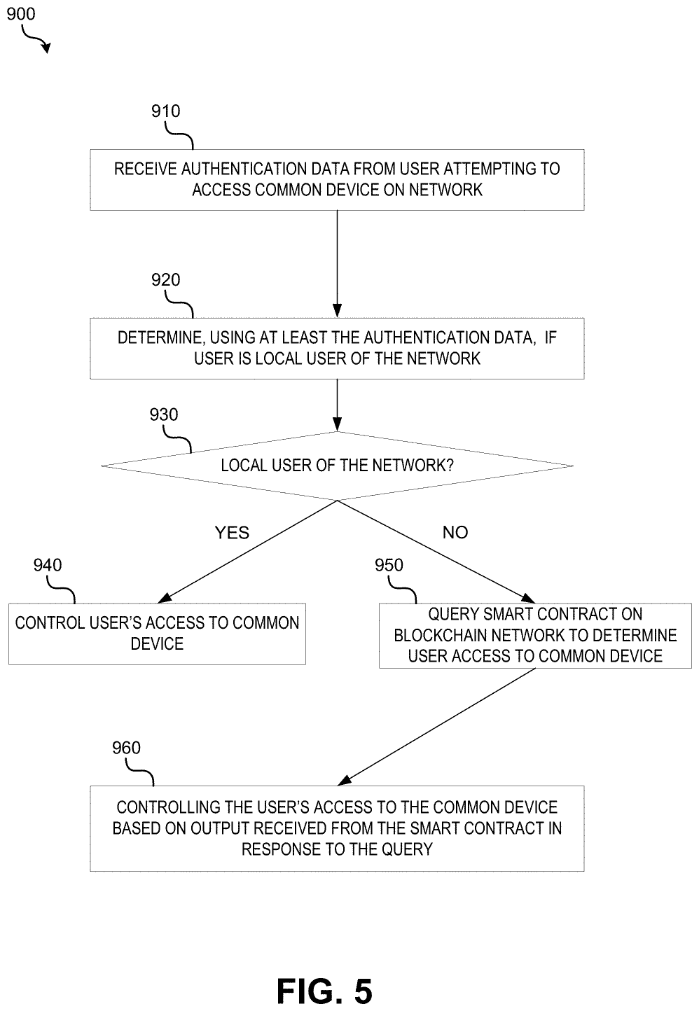

FIG. 5 is an operational flow diagram illustrating an example method 900 in accordance with implementations of the disclosure. For example method 900 may be implemented by a controller 600 and/or edge server of a networking system. In some implementations, method 900 may be implemented by executing one or more of instructions 614-616.

At operation 910, authentication data is received from a user attempting to access a common device on a network. In some implementations, the authentication data may be used to identify the user and provide network access to the user. For example, the authentication data may include user credentials or some other type of data that may be used to identify the user and provide network access to the user. In some implementations, the authentication data may be received by a NAD 400, and a controller 600 may authenticate the user using an access control list or some other suitable mechanism. The common device the user is attempting to access may be a printer, a projector, a terminal, or some other common device 300.

At operation 920, the authentication data is used to determine if the user attempting to access the common device is a local user of the network. In some implementations, if the user is a local user of the network, the user's access to the common device may be controlled in accordance with a local network policy governing common device access by local users. For example, a local data store 617 of user identities may be checked to determine if the user is a local user. For example, if the user is an employee of a branch office in the same location where the common device is present, the user's identity may be stored in local data store 617. Responsive to the user being a local user (decision 930), at operation 940 the local controller 600 (or a NAD or other suitable device) may control the user's access to the common device. For example, a local data store of user identities of common device permissions may allow or deny user access to the common device based on how the local network is configured. In some implementations, further described below, after the user is allowed or denied access to the common device, a smart contract (e.g., smart contract 810) may be queried to log the user's access of the common device on a blockchain. For example, a log of user's access of a printer may be forwarded to a smart contract for recording on a blockchain.

On the other hand, responsive to the user not being a local user of the network (decision 930), e.g., the user is a guest/customer or employee of another office associated with the enterprise, at operation 950 a smart contract 810 on the blockchain network may be queried to determine user access to the common device. The query may include the authentication data received from the user. At operation 960, the user's access to the common device may be controlled based on an output (e.g., an output determining whether to allow or deny the user access to the common device) received from the smart contract in response to the query.

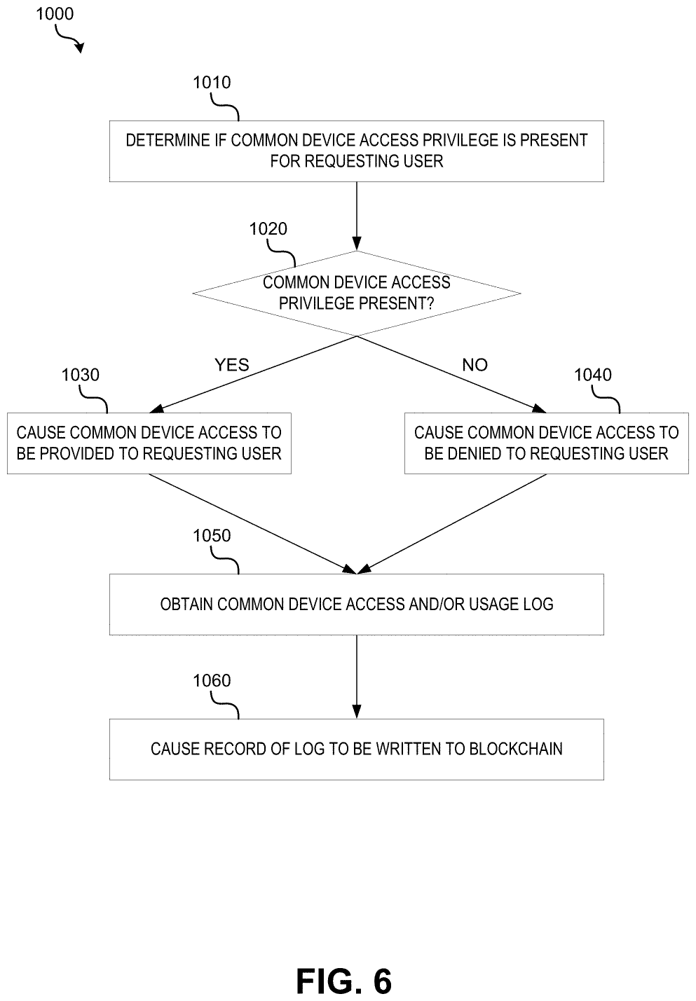

FIG. 6 is an operational flow diagram illustrating an example method 1000 that may be implemented by a smart contract 810 in accordance with implementations of the disclosure. For example, method 1000 may be implemented by a self-executing smart contract 810 in response to receiving input data including an identification of a user and identification of a common device the user is attempting to access. The input data may include the credentials supplied by a user device along with an identification of a common device the user device is attempting to access.

At operation 1010, it may be determined if a common device access privilege is present for the common device for the requesting user. For example, a smart contract 810 may check the last block of a blockchain 720 (e.g., a blockchain separate from the one the smart contract executes on) to determine if the requesting user device is authorized to access the common device. If the user is identified, the smart contract may check for common device access privileges associated with the user. In other implementations, the smart contract 810 may check a database of the smart contract or some other database to make this determination.

If the user is recognized (e.g., on list of permissioned users) and determined to have permission to access the common device (decision 1020), at operation 1030 the smart contract may cause common device access to be provided to the requesting user. For example, in some implementations the smart contract may output an instruction to a controller 600 or NAD 400 to allow the user access to the common device. In some implementations, the smart contract may directly interact with the common device itself, instructing it to allow access to the user.

On the other hand, if the user is not recognized, or if the user is recognized but does not have the necessary common device access privilege, at operation 1040 the smart contract may cause common device access to be denied to the requesting user. In instances where the user is denied access (e.g., because the user is not on the list of users according to the latest block on the blockchain), the user may be blocked after multiple unsuccessful attempts. In such implementations, the smart contract may maintain a database or other storage structure that tracks each time access has been denied to a requesting user device.

For example, in some implementations, the smart contract may output an instruction to a controller 600 or NAD 400 to deny the user access to the common device. In some implementations, the smart contract may directly interact with the common device itself, instructing it to deny access to the user.

In implementations, the allowed access or denial of access may be logged as an entry in the blockchain (e.g., blockchain 830) that the smart contract (e.g., smart contract 810) executes on. To this end, at operation 1050, a common device access and/or usage log may be obtained by the smart contract. For example, a log of the denial of the common device or the approval of the user's usage of the common device may be recorded by the smart contract. Additionally, the smart contract may obtain a log of the specific usage that occurred. For example, the smart contract may either obtain the log directly from the common device or through an intermediary device such as controller 600. At operation 1060, the smart contract may cause a record of the log to be the written to the blockchain (e.g., as the latest block in the blockchain 830).

By way of example, consider the case of a user requesting to print from a printer in a branch office. Once the smart contract validates that the user has the permission to print using the specified printer, it may cause the printer to complete the action (e.g., by communicating through controller 600). After printing is successful, the entry may be logged into the blockchain, including the details of what document was printed. If printing fails, the failure of the print job may be logged in the blockchain, along with reasons for the failure. In some instances, an alert may be sent to the network administrator of the failure. As the foregoing example illustrates, a common device (e.g., printer) may be turned into an Internet of Things (IoT) printer that runs based on a smart contract for user authorization and logs the usage securely in a blockchain that provides a secure store of the data with timestamps to provide an audit trail that enhances network security.

In this document, the terms “machine readable medium,” “computer readable medium,” and similar terms are used to generally refer to non-transitory mediums, volatile or non-volatile, that store data and/or instructions that cause a machine to operate in a specific fashion. Common forms of machine readable media include, for example, a hard disk, solid state drive, magnetic tape, or any other magnetic data storage medium, an optical disc or any other optical data storage medium, any physical medium with patterns of holes, a RAM, a PROM, EPROM, a FLASH-EPROM, NVRAM, any other memory chip or cartridge, and networked versions of the same.

These and other various forms of computer readable media may be involved in carrying one or more sequences of one or more instructions to a processing device for execution. Such instructions embodied on the medium, are generally referred to as “instructions” or “code.” Instructions may be grouped in the form of computer programs or other groupings. When executed, such instructions may enable a processing device to perform features or functions of the present application as discussed herein.

In this document, a “processing device” may be implemented as a single processor that performs processing operations or a combination of specialized and/or general-purpose processors that perform processing operations. A processing device may include a CPU, GPU, APU, DSP, FPGA, ASIC, SOC, and/or other processing circuitry.

The various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. Additionally, unless the context dictates otherwise, the methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
receiving authentication data from a user attempting to access a common device on a network;
determining, using at least the authentication data, if the user is a local user of the network;
responsive to the user not being the local user of the network:
querying a smart contract on a distributed ledger network to determine whether to grant the user access to the common device, wherein the query comprises the authentication data from the user; and
controlling the user's access to the common device based on an output received from the smart contract in response to the query.

2. The method of claim 1, wherein the smart contract comprises self-executing code that is configured to:
determine if the user has an access privilege associated with the common device the user is attempting to access in the network;
if the user is determined to have an access privilege associated with the common device: causing access to the common device to be granted to the requesting user; and
if the user is determined to not have an access privilege associated with the common device: causing a denial of access to the common device to the requesting user.

3. The method of claim 2, wherein the smart contract is configured to cause access to be granted or denied to the requesting user by communicating the output to a controller, edge server, or gateway that controls user access to the common device on the network.

4. The method of claim 2, wherein the smart contract is configured to cause access to be granted or denied to the requesting user by communicating the output to the common device on the network.

5. The method of claim 2, wherein the smart contract is configured to determine if the user has the access privilege based on user access privileges recorded on a distributed ledger.

6. The method of claim 2, wherein if the user is determined to have an access privilege associated with the common device, the smart contract is configured to cause a log of the common device's access to be written to a distributed ledger, and wherein if the user is determined to not have an access privilege associated with the common device, the smart contract is configured to cause a log of the denial of the common device's access to be written to the distributed ledger.

7. The method of claim 6, further comprising: transmitting the log of the common device's access by the user to the smart contract.

8. The method of claim 1, further comprising: deploying the smart contract on the blockchain network.

9. The method of claim 2, wherein the common device is a printer, a scanner, a projector, or a display.

10. The method of claim 1, further comprising: if the user is a local user of the network, controlling the user's access to the common device in accordance with a local network policy governing common device access by local users.

11. A method, comprising:
deploying a smart contract on a distributed ledger network, wherein the smart contract comprises self-executing code that is configured to:
determine if a user has an access privilege associated with a common device the user is attempting to access in a network;
if the user is determined to have an access privilege associated with the common device: causing access to the common device to be granted to the requesting user; and
if the user is determined to not have an access privilege associated with the common device: causing a denial of access to the common device to by the requesting user.

12. The method of claim 11, wherein if the user is determined to have an access privilege associated with the common device, the smart contract is configured to cause a log of the common device's access to be written to a distributed ledger, and wherein if the user is determined to not have an access privilege associated with the common device, the smart contract is configured to cause a log of the denial of the common device's access to be written to the distributed ledger.

13. The method of claim 12, wherein the smart contract is configured to cause access to be granted or denied to the requesting user by communicating the output to a controller, edge server, or gateway that controls user access to the common device on the network.

14. The method of claim 12, wherein the smart contract is configured to cause access to be granted or denied to the requesting user by communicating the output to the common device on the network.

15. The method of claim 12, wherein the smart contract is configured to determine if the user has the access privilege based on user access privileges recorded on a distributed ledger of a second distributed ledger network.

16. The method of claim 11, wherein the common device is a printer, a scanner, a projector, or a display.

17. A non-transitory computer readable medium have instructions stored thereon, that when executed by a processor, perform operations of:
receiving authentication data from a user attempting to access a common device on a network;
determining, using at least the authentication data, if the user is a local user of the network;
responsive to the user not being the local user of the network:
querying a smart contract on a distributed ledger network to determine whether or not to grant the user access to the common device, wherein the query comprises the authentication data of the user; and
controlling the user's access to the common device based on an output received from the smart contract in response to the query.

18. The non-transitory computer readable medium of claim 17, wherein the smart contract comprises self-executing code that is configured to:
determine if the user has an access privilege associated with the common device the user is attempting to access in the network;
if the user is determined to have an access privilege associated with the common device: causing access to the common device to be granted to the requesting user; and
if the user is determined to not have an access privilege associated with the common device: causing a denial of access to the common device to the requesting user.

19. The non-transitory computer readable medium of claim 18, wherein if the user is determined to have an access privilege associated with the common device, the smart contract is configured to cause a log of the common device's access to be written to a distributed ledger, and wherein if the user is determined to not have an access privilege associated with the common device, the smart contract is configured to cause a log of the denial of the common device's access to be written to the distributed ledger.

20. The non-transitory computer readable medium of claim 19, wherein the instructions, when executed by the processor, further perform an operation of: transmitting the log of the common device's access by the user to the smart contract.
